(19) United States
(12) Patent Application Publication
(10) Pub. No.: US 2006/0176527 A1
(43) Pub. Date: Aug. 10, 2006

(54) Image reading device and image reading method

(75) Inventors: Kenichi Kato, Kanagawa (JP); Hiroshi Kurono, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/338,776

(22) Filed: Jan. 25, 2006

(30) Foreign Application Priority Data
Feb. 4, 2005 (JP) 2005-028813
Feb. 4, 2005 (JP) 2005-029240

(51) Int. Cl. H04N 1/46

(52) U.S. Cl. 358/505

(57) ABSTRACT

In an image reading system, a photographic film is conveyed, an image frame is conveyed to a reading position, pre-scanned and fine scanned. An image obtained by pre-scanning is displayed on a display section. The film is conveyed after the inspection processing ends. Further, by using data output from six image surface detecting sensors disposed along a transverse direction of the film, inter-frame region candidates (edge candidates) are detected within an inspection range per frame. A region surmised to be between frames is detected from film light amounts input from the sensors. Edge slopes, the edges' density differences, are computed as evaluation values for detecting an edge to be used as a reference from among the candidates, and are compared. An edge having a largest density difference is extracted. With the extracted edge as a reference, an image frame position is determined while considering an image frame size.

### CROSS-REFERENCE TO RELATED APPLICATIONS

This application claims priority under 35 USC 119 from Japanese Patent Applications Nos. 2005-028813 and 2005-029240, the disclosures of which are incorporated by reference herein.

### BACKGROUND OF THE INVENTION

1. Technical Field

The present invention relates to an image reading method, and in particular, relates to an image reading method which reads an image frame recorded on a photographic film.

The present invention relates to an image reading device and an image reading method, and in particular, relates to an image reading method which reads an image frame recorded on a photographic film, and to an image reading device and an image reading method which read an image recorded on a recording medium such as a photographic film or the like.

2. Description of the Related Art

Conventionally, there have been known image outputting devices which read, by a scanner equipped with a reading sensor such as a CCD or the like, a film image recorded on a photographic film, and carry out image processings such as various types of correction or the like on the image data obtained by the reading, and output the image data which has undergone the image processings to a printer.

Among such image outputting devices, there are those which, in order to obtain a recorded image or a display image of a desired image quality, preliminarily read a film image (so-called prescanning), determine reading conditions corresponding to the density and the like of the film image (e.g., the light amount of the light illuminated on the film image, the charge accumulating time of the CCD, and the like), and read the film image under the determined reading conditions (so-called fine scanning).

For example, Japanese Patent Application Laid-Open (JP-A) No. 9-116670 (JPA '670) discloses a device which, after prescanning, carries out fine scanning during a period of time in which image processing of the image data obtained by the prescanning is carried out, and, after the fine scanning, feeds the frame.

Further, JP-A No. 11-27466 (JPA '466) discloses a device which carries out prescanning and fine scanning in continuation, and, at the point in time when fine scan data of one roll of photographic film is accumulated, outputs this fine scan data to a printer, in order to improve the usage efficiency of the printer.

In the devices disclosed in above-described JPA '670 and JPA '466, prescanning is carried out in order to determine the image reading conditions and the image processing conditions and the like for the time when the fine scanning is executed. However, there are cases in which the prescan image is displayed on a monitor after the prescanning, and the operator, while confirming the image, not only determines the image reading conditions and the image processing conditions and the like, but also carries out inspection processing such as trimming the image or changing the print size. In this inspection processing, if the image is trimmed or the print size is changed, the image reading conditions, such as the optimal optical magnification or the reading resolution or the like, change. Therefore, the original fine scan data cannot be used, and fine scanning must be executed again.

In the case of a so-called 135-size photographic film for example, positioning of an image frame of the photographic film is carried out by reading the amount of light of the photographic film at a detector, detecting the edge of the frame image, and determining the frame position.

In the case of a 135-size photographic film, the frame position can be determined by using information of two frames, in order to improve the accuracy of detecting the frame position.

For example, in the technique disclosed in JP-A No. 5-142661, at the time of carrying out positioning of an image frame by detecting the edge of the image frame of a photographic film, in a case in which there exists poor image frames whose edges cannot be detected, an amount of conveying of the photographic film, which is determined from the normal image frame length and the average value of the dimension between normal image frames, is determined from the edge of a normal image frame which is at the closest position, and by carrying out conveying of the photographic film, the accuracy of positioning the poor image frame can be improved.

However, in the above-described conventional techniques, there are cases in which, in order to execute fine scanning again, the photographic film must be rewound. Cases in which it is desired to trim the image or change the print size cannot be addressed efficiently.

In cases of using plural types of recording media in which the image frame sizes, in the direction orthogonal to the transverse direction which are recorded in a recording region of the same width, are respectively different as in the case of brownie films, the frame sizes are large. Therefore, if an attempt is made to use information of two frames as in the case of a 135-size photographic film, the device becomes large.

### SUMMARY OF THE INVENTION

In view of the aforementioned, it has been desired to provide an image reading method which enables fine scanning to be executed again after inspection processing.

It has also been desired to accurately determine an image frame position by using information of one frame.

A first aspect of the present invention is an image reading method comprising: conveying a photographic film in a predetermined direction such that an image frame recorded on the photographic film is positioned at a predetermined reading position; preliminarily reading an image by illuminating light onto the entire image frame; actually reading the image frame at a higher resolution than during the preliminary reading; displaying, on a display means, the image obtained by the preliminary reading; executing the actual reading again in a case in which re-execution of the actual reading is instructed due to results of a predetermined inspection processing based on the image displayed on the display means; and conveying the photographic film in the predetermined direction so that an image frame, which is a next object of reading, is positioned at the reading position.

In accordance with the invention, the photographic film is conveyed in a predetermined direction so that an image frame recorded on the photographic film is positioned at the predetermined reading position. The photographic film may be a photographic film in which no perforations are formed. An example of such a photographic film is a brownie film.

Then, light is illuminated onto the entire image frame, and the image is preliminarily read. In this preliminary reading, the image is read at a relatively low resolution. After the preliminary reading is executed, actual reading of the image frame is carried out at a higher resolution than that of the preliminary reading.

The image obtained by the preliminary reading is displayed on a display means. Here, for example, the operator can, while referring to the image displayed on the display means, carry out predetermined inspection processing such as instructing trimming of the image, instructing changing of the print size, instructing the image reading conditions, instructing the image processing conditions, or the like. In this case, if trimming of the image or changing of the print size is instructed, the image reading conditions, such as the reading resolution and the like, change, and actual reading must be carried out again.

Here, in a case in which re-execution of the actual reading is instructed due to the results of the predetermined inspection processing based on the image displayed on the display means, actual reading is carried out again.

Then, after the actual reading is finished, the photographic film is conveyed in the predetermined direction so that the image frame, which is the next object of reading, is positioned at the reading position.

In this way, the image reading conditions are changed, and the actual reading can be carried out again. Thus, even cases in which trimming of the image or changing of the print size is instructed can be addressed, and the image can be read more properly.

Moreover, preliminary reading and actual reading are carried out in continuation. However, the photographic film is not conveyed immediately thereafter, and rather, the photographic film is conveyed after the inspection processing. Therefore, even in cases in which actual reading is required again due to the results of the inspection processing, there is no need to convey the photographic film rearward and rewind it. In the case of a photographic film in which no perforations are formed, the photographic film is not necessarily returned accurately to the reading position when conveyed reversely. However, by invariably conveying the photographic film after the inspection processing as in the present invention, it is possible to prevent the effects of positional offset which arise due to reverse conveying.

At the time when the actual reading is executed, if setting is carried out to execute the reading at a higher resolution than that of the usual setting, there are cases in which the main scanning will not be finished at the point in time when the inspection processing is finished. At such times, when the actual reading must be carried out again due to the results of the inspection processing, the image data obtained by the actual reading which was previously in the midst of execution is not needed.

A second aspect of the present invention is an image reading device which conveys a recording medium on which image frames are recorded, and stops an image frame at a reading position, and reads an image, the image reading device comprising: a plurality of detecting sections which are disposed along a transverse direction which is orthogonal to a conveying direction of the recording medium, and which, by detecting densities of the recording medium, detect a plurality of edge candidates of an image frame recorded on the recording medium; a comparing section comparing density differences of the plurality of edge candidates detected by the plurality of detecting sections; and a determining section which, on the basis of results of comparison of the comparing section, determines a position of an image frame on the recording medium by using an edge candidate having a large density difference as a reference.

In accordance with the second aspect of the present invention, at the plurality of detecting sections which are disposed along the transverse direction which is orthogonal to the conveying direction of the recording medium, a plurality of edge candidates of the image frame recorded on the recording medium are detected by detecting the densities of the recording medium. For example, the detecting sections detect a plurality of edge candidates of the image frame recorded on the recording medium, by using one frame on the recording medium (e.g., a detection range equal to the image frame size+the interval between frames+a predetermined value) as the detection range.

A third aspect of the present invention is an image reading method of an image reading device which conveys a recording medium on which image frames are recorded, and stops an image frame at a reading position, and reads an image, the method comprising: detecting a plurality of edge candidates of an image frame recorded on the recording medium, by detecting densities of the recording medium by a plurality of detecting sections which are disposed along a transverse direction which is orthogonal to a conveying direction of the recording medium; comparing densities of the plurality of edge candidates detected; and on the basis of results of comparison, determining a position of an image frame on the recording medium by using an edge candidate having a large density difference as a reference.

In accordance with the third aspect of the present invention, in the detecting, a plurality of edge candidates of the image frame recorded on the recording medium are detected by detecting the densities of the recording medium by a plurality of detecting sections which are disposed along the transverse direction which is orthogonal to the conveying direction of the recording medium. For example, the detecting detects a plurality of edge candidates of the image frame recorded on the recording medium, by using one frame on the recording medium (e.g., a detection range equal to the image frame size+the interval between frames+a predetermined value) as the detection range.

### BRIEF DESCRIPTION OF THE DRAWINGS

FIG. 1 is a block diagram showing the schematic structure of an image reading device relating to an embodiment of the present invention.

FIG. 2 is a perspective view showing the exterior of a film carrier relating to the embodiment of the present invention.

FIG. 3 is a perspective view showing the exterior of the film carrier of FIG. 1, in a case in which masks, mask holding members, and a driving mechanism thereof have been removed.

FIG. 4 is a perspective view showing the exterior when viewing main portions of the film carrier relating to the embodiment of the present invention from an upstream side of a film conveying path.

FIGS. 5A and 5B are explanatory diagrams for explaining operation of suppressing curling of a photographic print by the film carrier relating to the embodiment of the present invention, where FIG. 5A shows a state immediately after a photographic film, in which a trough-like curl has arisen, is conveyed to an image reading section, and FIG. 5B shows a state in which the curl of the photographic film is suppressed.

FIG. 6 is a timing chart of processings which the image reading device and an operator execute.

FIG. 7 is a timing chart of processings which the image reading device and the operator execute.

FIG. 8 is a timing chart of processings which the image reading device and the operator execute.

FIG. 9 is a diagram showing the schematic structure of a scanner device relating to the embodiment of the present invention.

FIG. 10 is a schematic diagram showing the schematic structure of a conveying path.

FIG. 11 is a block diagram showing the structure of a controller which controls the scanner device relating to the embodiment of the present invention.

FIG. 12 is a flowchart showing an example of the flow of image frame detecting processing which is carried out at the controller of the scanner device relating to the embodiment of the present invention.

### DETAILED DESCRIPTION OF THE INVENTION

An embodiment of the present invention will be described hereinafter with reference to the drawings.

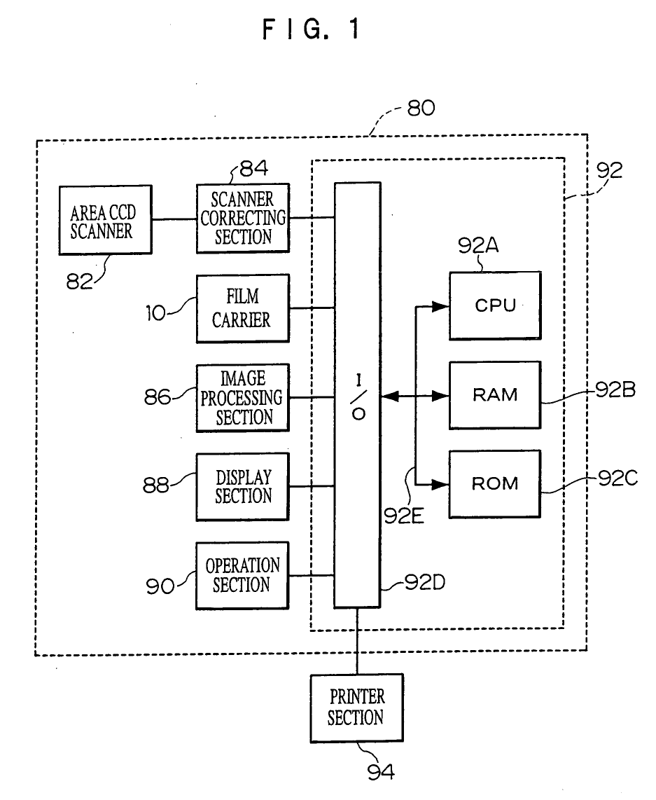

A block diagram of the schematic structure of an image reading device 80 relating to the present embodiment is shown in FIG. 1.

The image reading device 80 is structured so as to include an area CCD scanner 82, a scanner correcting section 84, a film carrier 10, an image processing section 86, a display section 88, an operation section 90, and a microprocessor 92.

The area CCD scanner 82 is for reading the respective image frames recorded on a photographic film. In the present embodiment, as an example, a film image of a photographic film in which no perforations are formed, e.g., a so-called brownie size (120 size, 220 size) photographic film, is used as the object of reading.

The area CCD scanner 82 is structured so as to include a light source, an optical lens, an area CCD serving as an image pickup element, an A/D converter, and the like, none of which are illustrated. The area CCD scanner 82 illuminates light, which is irradiated from the light source, onto the entire image frame recorded on the photographic film, and images the light which is transmitted therethrough onto the area CCD by the optical lens. Then, by reading the charges accumulated at the area CCD and carrying out A/D conversion, the area CCD scanner 82 obtains image data of the image frame.

The scanner correcting section 84 carries out various types of correction processings on the image data of the image frame inputted from the area CCD scanner 82. Concretely, the scanner correcting section 84 is structured so as to include, for example, a darkness correcting section, a defective pixel correcting section, a lightness correcting section, and the like. At the darkness correcting section, image data inputted from the area CCD scanner 82 in a state in which the light incident side of the area CCD is shaded by a shutter (data expressing the dark output level of the area CCD) is stored for each pixel, and correction is carried out by subtracting the dark output level for each pixel from the scan image data inputted from the area CCD scanner 82.

At the respective CCD cell units, there is dispersion in the photoelectric converting characteristic of the area CCD. At the lightness correcting section which is at the following stage of the defective pixel correcting section, the gain is determined for each pixel on the basis of image data of a film image for adjustment which is inputted from the CCD scanner 82 due to the film image for adjustment being read by the area CCD in a state in which the film image for adjustment, whose entire image surface is a uniform density, is set at the area CCD scanner 82. (The dispersion in the density of each pixel which this image data expresses is a cause of dispersion in the photoelectric converting characteristics of the respective CCD cells.) The image data of the film image which is the object of reading, which is inputted from the area CCD scanner 82, is corrected for each pixel.

In the image data of the film image for adjustment, in a case in which the density of a specific pixel greatly differs from the densities of the other pixels, there is some type of abnormality in the CCD cell corresponding to that specific pixel, and that specific pixel can be judged to be a defective pixel. The defective pixel correcting section stores the address of the defective pixel on the basis of the image data of the film image for adjustment, and, among the image data of the film image which is the object of reading which is inputted from the area CCD scanner 82, extrapolates data of the defective pixel from the data of the surrounding pixels, and newly generates data.

The image processing section 86 carries out various types of processings which will be described later on the image data of the image frame read by the area CCD scanner 82 (i.e., the scan image data). The image processing section 86 includes, for example, a reduction processing section, a correcting/converting section, a signal processing section, and the like, and carries out various types of image processings such as predetermined reduction processings, correcting/converting processings, digital signal processings, and the like. The image data which has been subjected to the image processings is outputted to a printer section 94 as image data for recording onto a photographic printing paper.

The display section 88 is structured by a CRT or a liquid crystal display or the like, and displays the read image, various menu screens for executing inspection processing which will be described later, and the like.

The operation section 90 is structured so as to include, for example, a keyboard, a mouse, and the like. Due to the operator operating the operation section 90, the operator can, while referring to the image displayed on the display section 88, instruct trimming of the image, designate changing of the print size, designate the image reading conditions, designate the image processing conditions, and the like.

The microprocessor 92 is structured to include a CPU 92A, a RAM 92B, a ROM 92C, and an input/output interface (I/O) 92D, and these elements are respectively connected via a bus 92E. The RAM 92B is structured by, for example, a DRAM or the like, and temporarily stores various types of data and the like. The ROM 92C is structured by, for example, a Flash ROM or the like whose stored contents are rewritable, and stores control programs, various types of parameters, and the like. The CPU 92A controls the aforementioned respective sections in accordance with the control programs stored in the ROM 92C.

The printer section 94 has R, G, B laser light sources, and illuminates, onto a photographic printing paper, laser light which is modulated in accordance with image data for recording which has been subjected to image processings by the image processing section 86, and records an image on the photographic printing paper by scanning exposure. The photographic printing paper on which the image is recorded is subjected to various processings such as color developing, bleaching/fixing, washing, and drying by a processor section (not shown). In this way, an image is formed on the photographic printing paper.

The film carrier 10 will be described next.

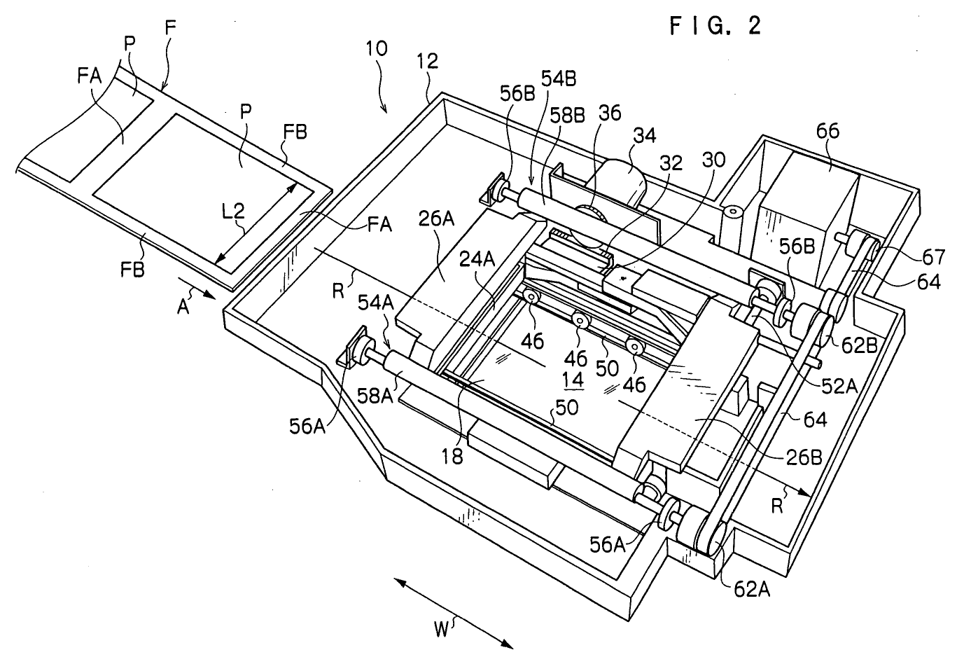

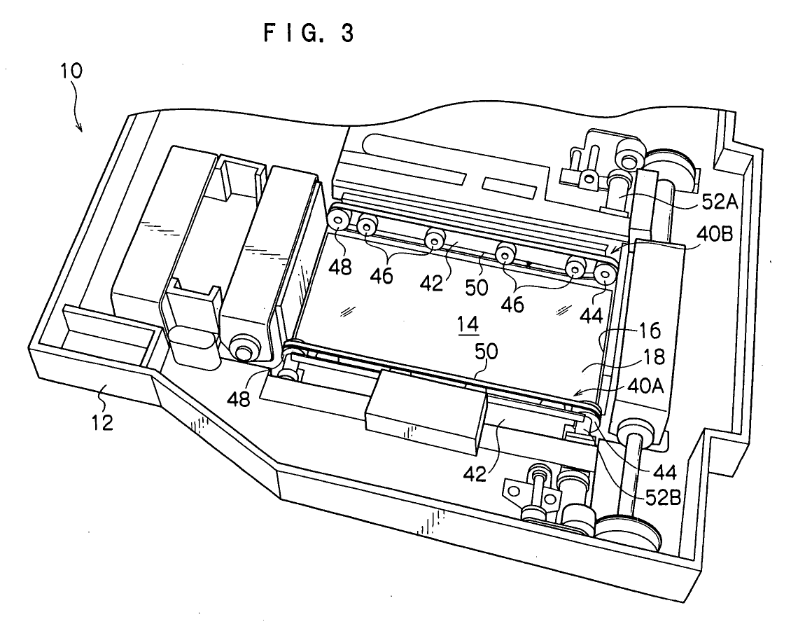

The film carrier 10 of the present embodiment is shown in FIGS. 2 through 4. The film carrier 10 is a film carrier for brownie films, and can be installed in and removed from a scanner device. As shown in FIGS. 2 and 3, a base stand 12 which is attached to a scanner device is provided at the film carrier 10. An image reading section 14, which is for reading an image as follows, is provided at the substantially central portion of the base stand 12: light, which exits from a light source portion of the scanner device (the area CCD scanner 82), is illuminated onto an image frame P recorded on a photographic film (brownie film) F, the light which passes through the photographic film F (film transmitted light) is imaged onto a light-receiving surface of an image pickup element (the area CCD) by a lens unit of the scanner device, and the film transmitted light is thereby converted into an electric image signal by the image pickup element. Further, a film conveying path R, which is for conveying the photographic film F at the image reading section 14, is formed at the top surface portion of the base stand 12 so as to extend along the transverse direction of the device (the direction of arrow W). This film conveying path is schematically shown by arrow R in the drawings.

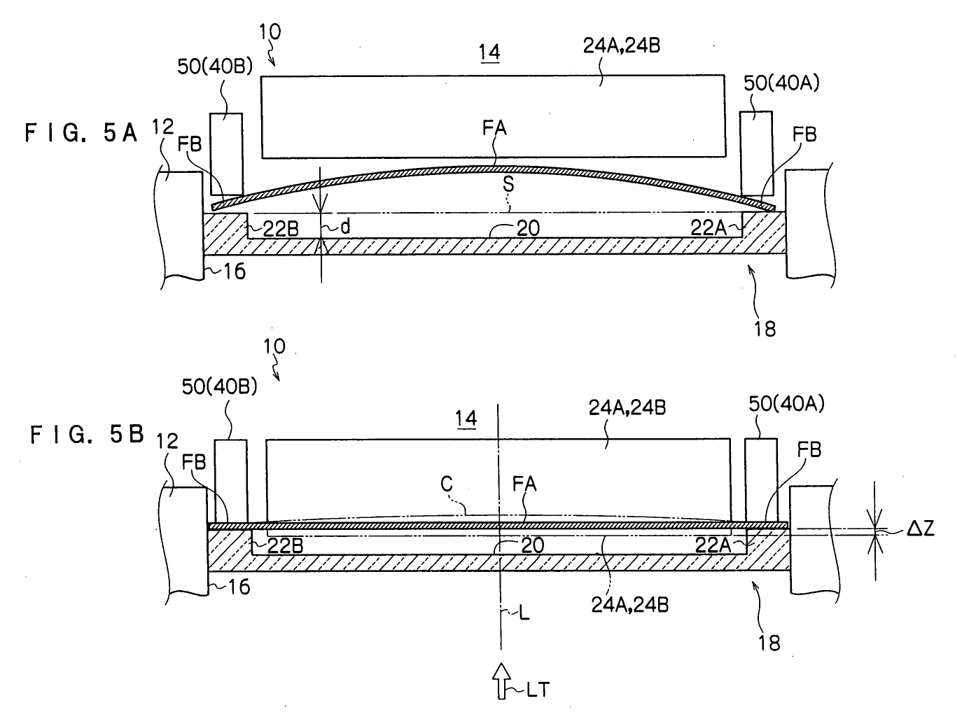

As shown in FIG. 3, a rectangular window portion 16, which is long along the transverse direction of the device, is formed at the image reading section 14. A base plate 18, which contacts the reverse surface of the photographic film F conveyed at the image reading section 14 and which is for setting the photographic film F at a reference position along a light illuminating direction (refer to optical axis L of FIG. 5B), is fit-into the window portion 16.

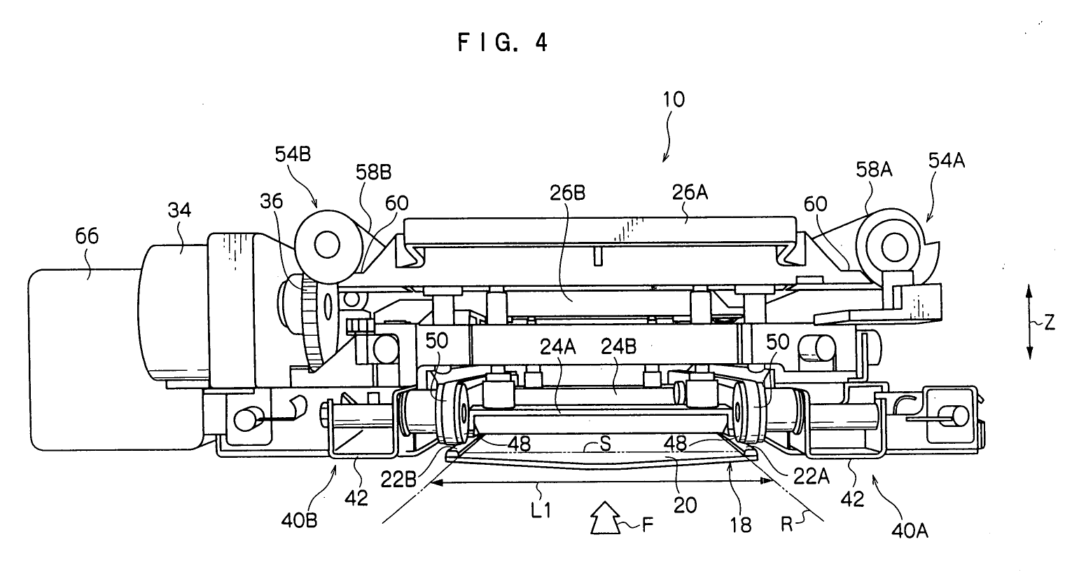

The base plate 18 is formed by a transparent glass plate. As shown in FIG. 4, a concave portion 20 is provided at the top surface of the base plate 18 so as to extend along the film conveying direction (the direction of arrow A) at a region corresponding to the image frame P of the photographic film F. Further, a pair of convex portions 22A, 22B, which form the concave portion 20, are provided at the top surface of the base plate 18 so as to extend along the both side edge portions in the direction orthogonal to the film conveying direction (i.e., in the film transverse direction). The aforementioned reference position along the light illuminating direction is structured by the respective top surfaces of the pair of convex portions 22A, 22B (an image reading reference plane S). Further, a groove width L1 of the concave portion 20 along the direction orthogonal to the film conveying direction is formed to be slightly larger than a width L2 of the image frame P.

A pair of masks 24A, 24B, which extend along the direction orthogonal to the film conveying direction, are provided at the upstream side and the downstream side of the image reading section 14 at the film conveying path R. The lengths of the pair of masks 24A, 24B, in the direction orthogonal to the film conveying direction, are slightly smaller than the groove width L1 of the concave portion 20 of the base plate 18 (see FIG. 4). The pair of masks 24A, 24B are mounted to and held at mask holding members 26A, 26B which are supported at the base stand 12 by an unillustrated supporting mechanism, so as to be able to be raised and lowered, and so as to be able to move along the film conveying direction (the direction of arrow W) so as to be able to approach and move apart from one another.

In this way, as the mask holding members 26A, 26B rise and fall, the masks 24A, 24B approach and move away from the base plate 18 (in the directions of arrow Z in FIG. 4). When the mask holding members 26A, 26B are raised, the masks 24A, 24B are disposed so as to be separated from the base plate 18 by a predetermined distance. When the mask holding members 26A, 26B are lowered to a predetermined position, the masks 24A, 24B are stopped at a predetermined position which substantially coincides with the image reading reference plane S.

A rack 30, which extends along the film conveying direction, is connected to one end portions of the mask holding members 26A, 26B. A driving gear 36 of a mask moving motor 34, which is formed by a stepping motor, meshes together with a rack gear 32 of the rack 30. In this way, when the mask moving motor 34 rotates and drives the driving gear 36, the rack 30 moves along the film conveying direction. As the rack 30 moves, the mask holding members 26A, 26B approach and move away from one another while moving along the film conveying direction, such that the mask position by the masks 24A, 24B is changed. Changes in the image frame size in the conveying direction of the photographic film F can be addressed by this displacement of the masks 24A, 24B.

A pair of tight-pressing units 40A, 40B are provided at the sides of the image reading section 14 in the direction orthogonal to the film conveying direction. The pair of tight-pressing units 40A, 40B have tight-pressing bases 42 which extend along the film conveying direction. The tight-pressing bases 42 are supported at the base stand 12 by an unillustrated supporting mechanism so as to be able to rise and fall. As the mask holding members 26A, 26B rise and fall, the tight-pressing bases 42 approach and move apart from the base plate 18 (in the directions of arrow Z in FIG. 4).

As shown in FIG. 3, a driving pulley 44, four idler pulleys 46, and a driven pulley 48, which are disposed in a row along the film conveying direction, are rotatably provided at the inner side surface of the tight-pressing base 42. An endless belt 50 is trained about the driving pulley 44, the idler pulleys 46, and the driven pulley 48. The belts 50 extend along the film conveying direction, and, as shown in FIG. 4, are disposed so as to oppose the convex portions 22A, 22B which are provided on the top surface of the base plate 18. Further, when the mask holding members 26A, 26B are raised, the belts 50 are disposed so as to be separated from the convex portions 22A, 22B by a predetermined distance. When the mask holding members 26A, 26B are lowered to a predetermined position, after the masks 24A, 24B are stopped at the above-described predetermined position, the belts 50 tightly press the convex portions 22A, 22B.

As shown in FIG. 3, rotating/driving shafts 52A, 52B are connected to the driving pulleys 44 of the tight-pressing units 40A, 40B, respectively. Due to the rotating/driving shafts 52A, 52B being rotated and driven synchronously by an unillustrated belt driving motor, the belts 50 of the tight-pressing units 40A, 40B are rotated and driven by the driving pulleys 44, and rotate and move synchronously in a predetermined direction.

As shown in FIG. 2, a pair of eccentric cams 54A, 54B are disposed at the outer sides of the tight-pressing units 40A, 40B in the direction orthogonal to the film conveying direction. Both end portions of the pair of eccentric cams 54A, 54B are rotatably supported by a pair of bearing portions 56A, 56B. As shown in FIG. 4, cam portions 58A, 58B abut pressed surface portions 60 which are formed at the both side portions of the top surfaces of the mask holding members 26A, 26B.

Timing pulleys 62A, 62B are mounted to the distal ends of one end portions of the eccentric cams 54A, 54B. A single, endless timing belt 64 is trained between these timing pulleys 62A, 62B and a driving pulley 67 of a tight-pressing motor 66 which is formed by a stepping motor. In this way, when the tight-pressing motor 66 operates and the driving pulley 67 is rotated and driven, the rotational driving force thereof is transmitted via the timing belt 64 to the timing pulleys 62A, 62B, the eccentric cams 54A, 54B rotate synchronously, and the cam surfaces of the cam portions 58A, 58B are moved vertically. When the pressed surface portions 60 are pressed by the cam portions 58A, 58B of the eccentric cams 54A, 54B, the mask holding members 26A, 26B fall and approach the base plate 18. Further, when the pressing by the cam portions 58A, 58B is released, the mask holding members 26A, 26B rise-up due to the spring forces of spring members (not shown) provided at the supporting mechanism, and move away from the base plate 18.

Next, the image reading operation of reading the image from the image frame P, which is recorded on the photographic film F, by the film carrier 10 of the present embodiment which is structured as described above, and the effects thereof, will be described.

In the film carrier 10 of the present embodiment, due to the rotation and movement of the belts 50 of the tight-pressing units 40A, 40B, the photographic film F is conveyed along the film conveying path R provided at the top surface portion of the base stand 12. When the photographic film F is stopped at the image reading section 14 as shown in FIG. 5A, the tight-pressing motor 66 is driven, and the mask holding members 26A, 26B are lowered.

As the mask holding members 26A, 26B are lowered, both conveying direction edge portions FA (see FIG. 2) at the film surface are pressed and are pushed-in to the image reading reference plane S, by the pair of masks 24A, 24B which are moved in the direction of approaching the base plate 18. Further, after this pressing by the masks 24A, 24B, as the mask holding members 26A, 26B are lowered, the belts 50 of the pair of tight-pressing units 40A, 40B, which are moved in the direction of approaching the base plate 18, tightly press both transverse direction edge portions FB at the film surface. As shown in FIG. 5B, the photographic film F is set at the image reading section 14 with the both edge portions FB nipped between the belts 50 and the convex portions 22A, 22B of the base plate 18.

In this state, light (arrow LT in FIG. 5B), which exits from the light source portion of the scanner device, passes through the base plate 18 and is illuminated onto the image frame P recorded on the photographic film F. The light transmitted through the image frame P (transmitted light) is imaged on the light-receiving surface of the image pickup element by the lens unit of the scanner device. In this way, the film transmitted light is converted into an electric image signal by the image pickup element, and is read as an image.

Here, the trough-shaped curl, which arises in the photographic film F and which has curvature in the film transverse direction, is greatly reduced due to the both edge portions FA in the film conveying direction being pressed by the masks 24A, 24B, before the both edge portions FB in the film transverse direction are nipped between the belts 50 of the tight-pressing units 40A, 40B and the convex portions 22A, 22B of the base plate 18. Accordingly, even if there is a great curl, it can be reliably suppressed, and the photographic film F can be made to have good planarity.

Further, in the state in which the masks 24A, 24B have moved apart from the base plate 18 and pressing of the photographic film F is released, due to the relative movement of the mask holding members 26A, 26B due to the driving of the mask moving motor 34, the masks 24A, 24B are moved so as to approach and move away from one another along the film conveying direction in accordance with the size of the image frame P, and are disposed at a predetermined mask position. Due to this displacement of the masks 24A, 24B, changes in the image frame size in the conveying direction can be addressed without damaging the photographic film F.

With regard to a photographic film F in which a large, trough-shaped curl has arisen, if the pair of masks 24A, 24B which press the both edge portions FA in the film conveying direction are, for example, merely moved to the reference position along the light illuminating direction (the image reading reference plane S), there are cases in which a curl which exceeds an allowable range remains in the central portion of the photographic film F. Moreover, when the film conveying direction both edge portions FA are, for example, tightly pressed at the base plate 18 due to the pressing by the pair of masks 24A, 24B, there are cases in which an air pocket forms between the photographic film F and the base plate 18 and it is difficult to collapse the curl.

In such cases, the concave portion 20 may be provided along the film conveying direction at a region of the base plate 18 corresponding to the image frame P, and as shown by the two-dot chain line in FIG. 5B, the masks 24A, 24B may be moved to as to enter into the concave portion 20 of the base plate 18 by an amount ΔZ, and the conveying direction both edge portions FA at the photographic film F may be pressed. In this way, the both edge portions FA are pushed-in further than the reference position along the light illuminating direction, and it is possible to keep a curl C, which remains at the central portion of the photographic film, within the allowable range. Further, by stopping the masks 24A, 24B, which enter into the concave portion 20, at positions at which they do not contact the concave portion 20, the conveying direction both edge portions FA at the photographic film F are tightly pressed by the base plate 18, no air pocket is formed between the photographic film F and the base plate 18, and the curl C can be prevented from becoming hard to collapse.

In the present embodiment, the photographic film F, which is conveyed at the image reading section 14 along the film conveying path R, is conveyed by the belts 50 which are provided at the tight-pressing units 40A, 40B so as to be able to rotate and move along the conveying direction. Therefore, even short photographic films, which have been cut to a single frame or plural frames, can be conveyed automatically.

The above-described embodiment is structured, for example, such that the mask position is changed due to the masks 24A, 24B approaching and moving away from one another. However, the mask position may be changed by making one of the masks 24A, 24B approach and move away from the other.

The effects of the present embodiment will be described next.

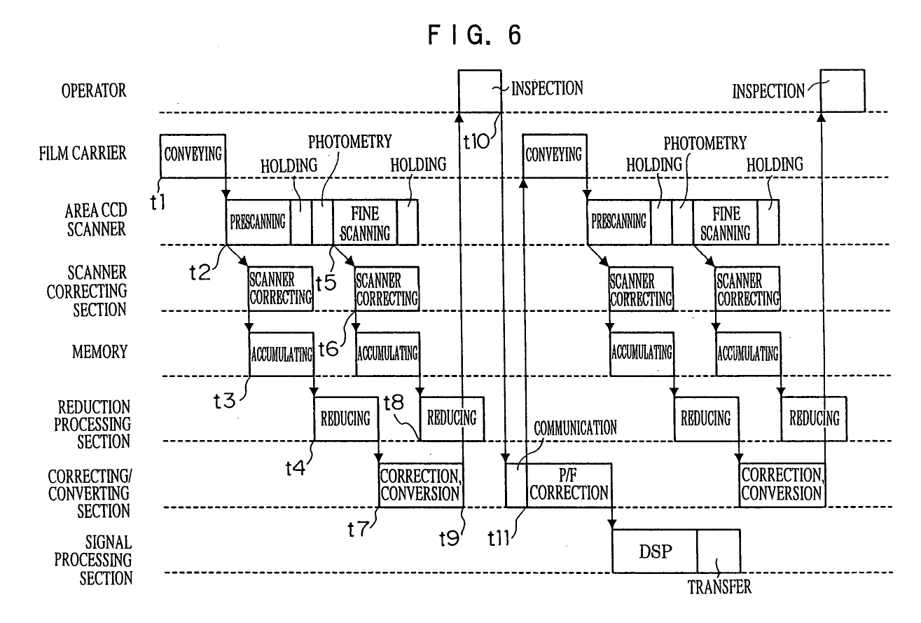

A timing chart of the processings executed by the operator and the respective sections of the image reading device 80 is shown in FIG. 6.

First, at time t1, the CPU 92A instructs the film carrier 10 to convey the photographic film. The film carrier 10 thereby releases the tight pressing of the photographic film by the tight-pressing units 40A, 40B and the like, and conveys the photographic film such that the image frame, which is the next object of reading, is positioned at the image reading section 14, and tightly presses the photographic film by the tight-pressing units 40A, 40B and the like.

Then, when the CPU 92A, at time t2, instructs the area CCD scanner 82 to execute prescanning, i.e., reading of the image frame at a low resolution, the light exiting from the light source of the area CCD scanner 82 is illuminated onto the entire image frame of the image reading section 14, and the light which is transmitted therethrough is imaged on the area CCD via the optical lens. The charges accumulated at the area CCD are successively read-out and A/D converted, and are outputted to the scanner correcting section 84 as prescan data. Note that the prescan data is held until time t4 when the scanner correction ends.

From time t3, the scanner correcting section 84 executes scanner correction, i.e., defective pixel correction and the like. The corrected prescan data is accumulated in the memory, i.e., the RAM 92B.

When scanner correction ends, at time t4, the CPU 92A instructs the area CCD scanner 82 to carry out photometric processing. In this way, the area CCD scanner 82 carries out a predetermined photometric processing. On the basis of the results thereof, image reading conditions, such as the charge accumulating time during fine scanning and the like, are determined. Note that the charge accumulating time and the like may be determined on the basis of the results of prescanning, and in this case, the photometric processing can be omitted.

At time t5 when the photometric processing ends, the CPU 92A instructs the area CCD scanner 82 to execute fine scanning, i.e., reading of the image frame at a high resolution. In this way, the light, which is irradiated from the light source of the area CCD scanner 82, is illuminated onto the entire image frame of the image reading section 14, and the light which is transmitted therethrough is imaged on the area CCD via the lens. At this time, charges of an amount corresponding to the charge accumulating time which was determined in the photometric processing, are accumulated at the area CCD. The charges accumulated at the area CCD are successively read-out and A/D converted, and are outputted to the scanner correcting section 84 as fine scan data. Note that the fine scan data is held until time t8 when the scanner correction ends.

Then, in the same way as during prescanning, scanner correction is executed by the scanner correcting section 84 from time t6, and the corrected fine scan data is accumulated in the RAM 92B.

At the reduction processing section of the image processing section 86, when the scanner correction ends at time t4, reduction processing of the image frame is carried out on the basis of the prescan data. Note that the reduction processing may be carried out on the fine scan data as well at time t8.

Then, when the reduction processing is completed, at time t7, predetermined correction/conversion processings are carried out at the correcting/converting section of the image processing section 86. Concretely, the correction processings and conversion processings are, for example, the processing of converting the prescan data to a density which is easier for people to look at, the processing of properly correcting the tint and the density, the conversion processing needed in order to display on the display section 88 the image obtained by prescanning, and the like.

When the correction/conversion processings on the prescan data are finished, at time t9, the prescan image after processing is displayed on the display section 88.

In this way, prescanning and fine scanning are carried out in continuation, and fine scanning and various types of image processings on the prescan data are executed in parallel.

Due to the operator viewing the prescan image which is displayed on the display section 88 and operating the operation section 90, the operator carries out inspection processing for instructing, for example, trimming of the image or changing of the print size, or instructing the image reading conditions, the image processing conditions, or the like.

In this inspection processing, in a case in which an operation requiring the execution of fine scanning again, e.g., trimming of the image or changing of the print size or the like, is not particularly instructed, at time t10, predetermined communication with the printer section 94 is carried out. Because the image which is read at the image reading device 80 is to be exposed onto a photographic printing paper at the printer section 94, in this communication, it is confirmed whether or not preparations at the printer section 94 have been completed, and the like.

Then, after communication is completed, at time t11, P/F correction, which corrects the differences between the prescan data and the fine scan data, is carried out at the correcting/converting section of the image processing section 86. Thereafter, at the signal processing section of the image processing section 86, DSP, i.e., a predetermined digital signal processing, is carried out, and the data is transferred to the printer section 94.

When communication with the printer section 94 ends at time t11, conveying of the photographic film is carried out in parallel with the P/F correction. Namely, the tight pressing of the photographic film by the tight-pressing units 40A, 40B and the like is released, and the photographic film is conveyed. The photographic film is conveyed such that the image frame which is the next object of reading is positioned at the image reading section 14, and the photographic film is tightly pressed by the tight-pressing units 40A, 40B and the like. Thereafter, processings which are the same as those described above are carried out.

In a case in which the operator instructs trimming of the image or changing of the print size in the inspection processing, the image reading conditions, such as the optimal optical magnification and the reading resolution and the like, change. Therefore, the fine scan data, which was obtained by the fine scanning executed previously at time t5, can no longer be used. Thus, fine scanning of the same image frame must be carried out again.

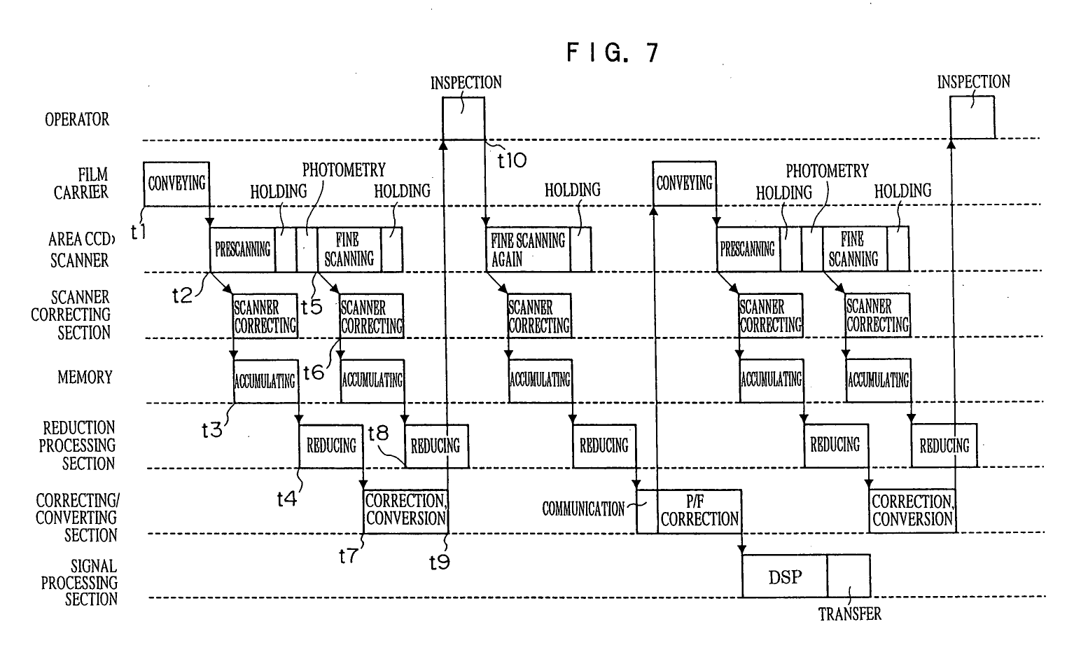

In this case, as shown in FIG. 7, at time t10, the CPU 92A again sets the image reading conditions and the like, and instructs the area CCD scanner 82 to execute fine scanning again under these conditions. In this way, fine scanning of the same image frame is executed again. Then, in the same way as in the fine scanning which was first carried out, after scanner correction and various types of image processings and the like are carried out, the data is transferred to the printer section 94. Note that the conveying of the photographic film is carried out after communication with the printer section 94 is completed after the fine scanning is carried out again.

In this way, in the present embodiment, because fine scanning can be executed again, it is possible to handle even cases in which the image reading conditions must be changed due to trimming of the image or changing of the print size or the like, and images can be read more correctly.

Further, although prescanning and fine scanning are carried out in continuation, the photographic film is not conveyed immediately thereafter, but rather, the photographic film is conveyed after the inspection processing. In this way, even in cases in which fine scanning becomes needed again in the inspection processing, there is no need to convey the photographic film rearward and rewind it. In the case of a photographic film in which no perforations are formed such as a brownie film, the photographic film is not necessarily accurately returned to the reading position when conveyed reversely. However, by invariably conveying the photographic film after the inspection processing as in the present embodiment, it is possible to prevent the effects of positional offset which arise due to reverse conveying.

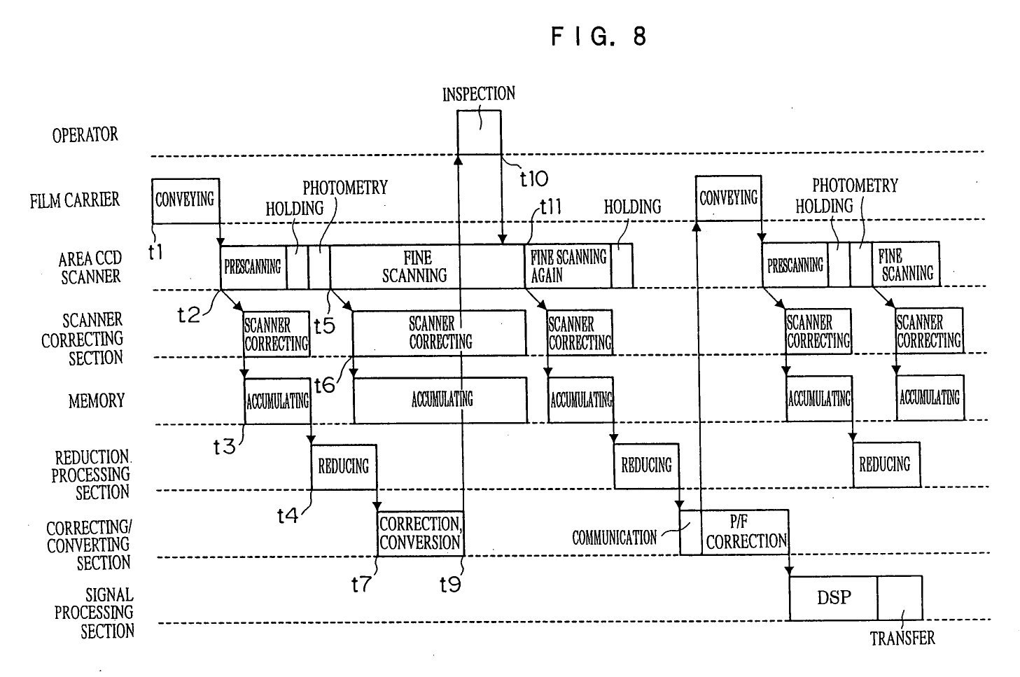

Moreover, the image processing and the inspection processing on the prescan data, and the fine scanning are executed in parallel. Therefore, in a case in which, as an image reading condition of the fine scanning, setting is carried out so as to read at a higher resolution than usual, there is the possibility that, as shown in FIG. 8, the fine scanning will not be completed even at the time when the inspection processing is completed by the operator, i.e., at time t10.

In such a case, the CPU 92A discontinues execution of the fine scanning, and instructs the area CCD scanner 82 to re-do the fine scanning. The fine scanning is thereby carried out again from the start at time t11. In this way, in a case in which fine scanning is in the midst of being carried out even if the inspection processing is completed, the fine scanning is discontinued, and fine scanning is executed again. Therefore, it is possible to prevent the scan cycle from becoming unnecessarily long.

The present invention has been described in detail by the above-described specific embodiment, but the present invention is not to be limited to this embodiment, and other, various forms can be embodied within the scope of the present invention.

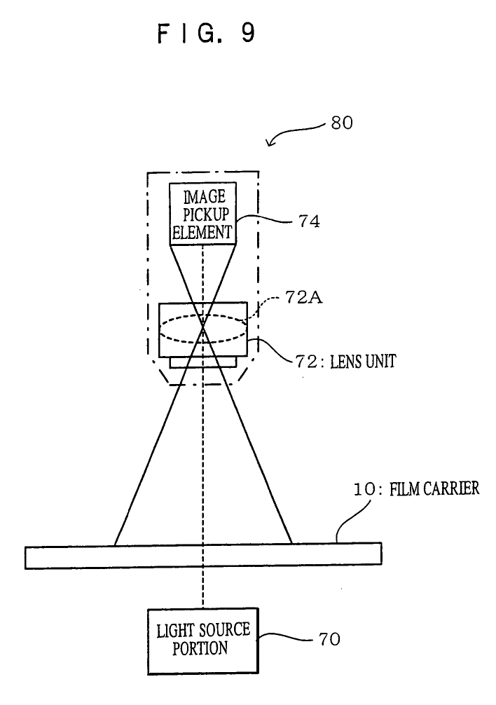

The schematic structure of the scanner device relating to the embodiment of the present invention is shown in FIG. 9.

As shown in FIG. 9, the scanner device 80 illuminates light from a light source portion 70 onto the photographic film F which is set at the film carrier 10, and images the light, which is transmitted through the photographic film F, onto the light-receiving surface of an image pickup element 74, such as a CCD area sensor or the like, by a lens unit 72. In this way, the film transmitted light is converted into an electric image signal by the image pickup element 74, and the image is read. Note that the lens unit 72 includes a focal lens 72A for adjusting the focal point imaging on the image pickup element 74, and focal point adjustment with respect to the photographic film F can be carried out by moving the focal lens 72A.

The film carrier 10 is a film carrier for brownie films, and can be installed in and removed from the scanner device 80. As shown in FIGS. 1 and 2, the base stand 12 which is attached to the scanner device 80 is provided at the film carrier 10. The image reading section 14, which is for reading an image as follows, is provided at the substantially central portion of the base stand 12: light, which exits from the light source portion 70 of the scanner device 80, is illuminated onto the image frame P recorded on the photographic film (brownie film) F, the light which passes through the photographic film F (film transmitted light) is imaged onto a light-receiving surface of the image pickup element 74, which is a CCD area sensor or the like, by the lens unit 72 of the scanner device 80, and the film transmitted light is thereby converted into an electric image signal by the image pickup element. Further, the film conveying path R, which is for conveying the photographic film F at the image reading section 14, is formed at the top surface portion of the base stand 12 so as to extend along the transverse direction of the device (the direction of arrow W). This film conveying path is schematically shown by arrow R in the drawings.

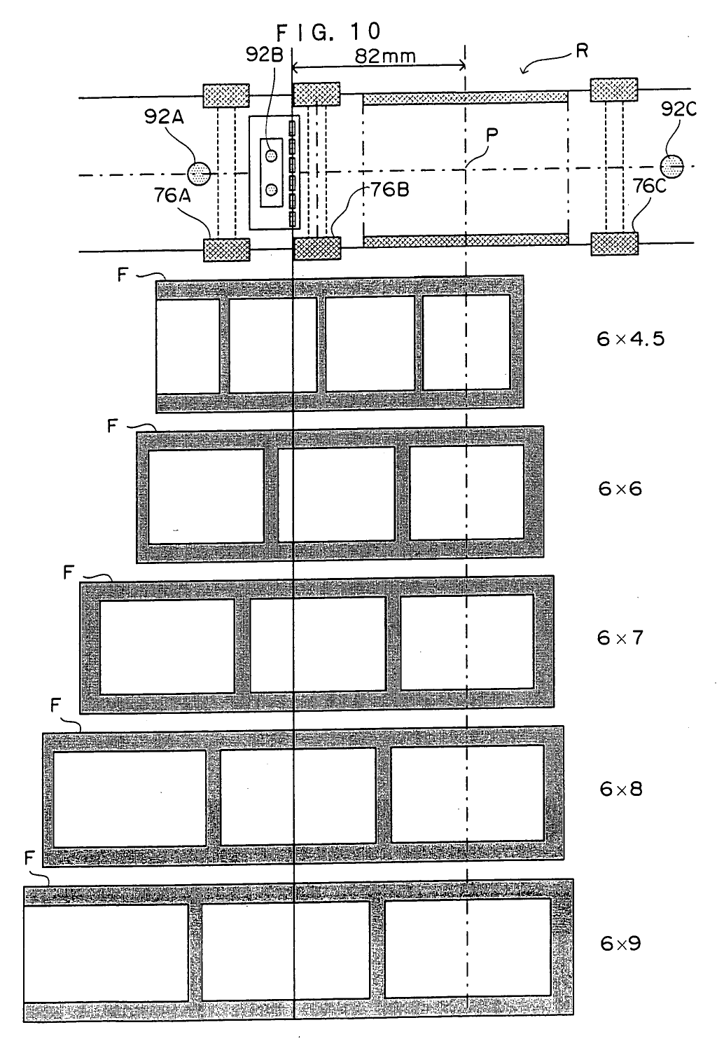

FIG. 10 is a schematic diagram which shows the schematic structure of the conveying path R.

As shown in FIG. 10, the conveying path R is formed by a first conveying roller 76A, a second conveying roller 76B, the belts 50 of the tight-pressing units 40A, 40B, and a third conveying roller 76C. The photographic film F is conveyed by the first conveying roller 76A, the second conveying roller 76B, the belts 50, and the third conveying roller 76C in that order.

A loading detecting sensor 92A, which detects the start of the conveying of the photographic film to the film carrier 10, is provided at the upstream side, in the conveying direction of the photographic film F, of the first conveying roller 76A. A discharge detecting sensor 92C, which detects the discharging of the photographic film F, is provided at the downstream side, in the conveying direction of the photographic film F, of the third conveying roller 76C.

A plurality of (six in the present embodiment) image surface detecting sensors 98 are disposed in a row along the transverse direction of the photographic film F, between the first conveying roller 76A and the second conveying roller 76B. A check tape detecting sensor 92B, which detects a check tape (a check tape or the like on which is written the same number as the receipt bag in which the photographic film F is placed by the customer), is disposed at the upstream side, in the conveying direction of the photographic film F, of the image surface detecting sensors 98.

The image surface detecting sensors 98 are sensors for detecting the image frame position from the densities on the photographic film F, by detecting the amounts of light which are illuminated from the light source portion 70 and pass through the photographic film F. In detail, the image surface detecting sensors 98 are disposed at a position which is located 82 mm toward the photographic film F conveying direction upstream side, from a reading center P of the image reading section 14. There are plural types of brownie films of different image sizes (6×4.5, 6×6, 6×7, 6×8, 6×9), and the image surface detecting sensors 98 are disposed at a position which is not between frames at the time when a given image frame of any of these image sizes is stopped at the reading central position of the image reading section 14. In the present embodiment, as shown in FIG. 6, because there is the second conveying roller 76B, when a frame of a 6×4.5 size brownie film is at the reading center P, the image surface detecting sensors 98 cannot be disposed at the image frame region of the next frame, and therefore, the image surface detecting sensors 98 are disposed at a position which is 82 mm toward the photographic film F conveying direction upstream side from the reading center P (in the case of a 6×4.5 brownie size film, the position of the image region of the second frame from the reading center P). With such an arrangement, at times when the conveying of the photographic film F is accelerated or decelerated, the image surface detecting sensors 98 are at a position at which they do not detect a region between frames (an image edge) at any of the image sizes, and detection by the image surface detecting sensors 98, which excludes effects due to acceleration and deceleration of the conveying of the photographic film F, is possible.

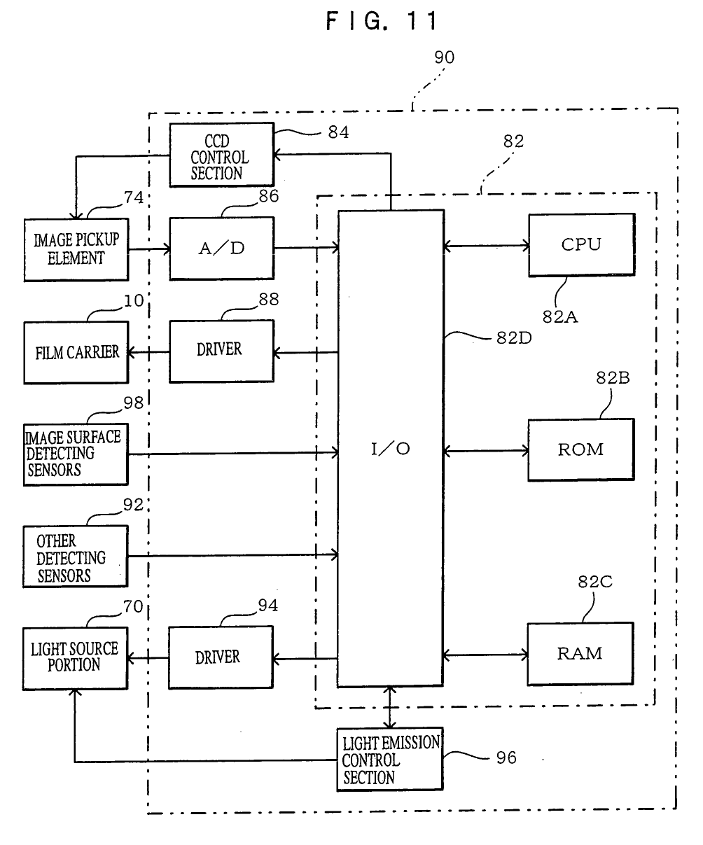

A controller which controls the scanner device 80 will be described next. FIG. 11 is a block diagram showing the structure of a controller 90 which controls the scanner device 80 relating to the embodiment of the present invention.

The scanner device 80 is controlled by the controller 90 shown in FIG. 11.

The controller 90 is structured to include a microcomputer 82. The microcomputer 82 is structured by a CPU 82A, a ROM 82B, a RAM 82C, an input/output port (I/O) 82D, and buses such as data buses and system buses and the like which connect these elements.

The image pickup element 74 is connected to the I/O 82D via an A/D converter 86. A driver 88, which is for driving the various types of motors of the film carrier 10, and a driver 94, which is for controlling the emission of light of the light source portion 70, are connected to the I/O 82D. The various types of motors of the film carrier 10 are connected to the driver 88. An AF motor 98 is connected to a driver 92, and the light source portion 70 is connected to the driver 94.

A light emission control section 96, which carries out light emission control of the light source portion 70, and a CCD control section 84, which controls the reading timing and the like of the image pickup element 74, are connected to the I/O 82D. The light emission control section 96 is connected to the driver 94, and the CCD control section 84 is connected to the image pickup element 74.

The CCD control section 84 controls the reading timing of the image pickup element 74 in accordance with a predetermined timing (clock). A light emission control section 118 carries out light emission control such that the light source portion 70 emits light during the reading timing carried out by a CCD control section 120. Further, in the control of the light source portion 70 by the light emission control section 96, during a predetermined time period, a predetermined current value is inputted to the light source portion 70 and control of the light emitting timing is carried out.

The above-described six image surface detecting sensors 98 are connected to the I/O 82D. Other detecting sensors (e.g., the loading detecting sensor 92A, the check tape detecting sensor 92B, the discharge detecting sensor 92C, and the like) are also connected to the I/O 82D. The results of detection by the respective detection sensors are inputted to the microcomputer 82. On the basis of the results of detection of the respective sensors, control of the conveying of the photographic film F by the microcomputer 82 is carried out.

Next, the image reading operation of reading an image from the image frame P, which is recorded on the photographic film F, by the film carrier 10 of the present embodiment which is structured as described above, and the effects thereof, will be described.

Due to the CPU 82A pulse-driving the respective motors of the film carrier 10 via the driver 88, at the film carrier 10, the driving of the first conveying roller 76A, the second conveying roller 76B, the belts 50 of the tight-pressing units 40A, 40B, and the third conveying roller 76C is controlled. The photographic film F is conveyed along the film conveying path R provided at the top surface portion of the base stand 12, and is stopped at the image reading section 14 as shown in FIG. 4A. At this time, at the controller 90, image frame detecting processing which will be described later is carried out in order to accurately control the stopping of the conveying of the photographic film F.

When the image frame of the photographic film F is stopped at the image reading section 14, the CPU 82A drives the tight-pressing motor 66, and the mask holding members 26A, 26B are lowered. As the mask holding members 26A, 26B are lowered, the both conveying direction edge portions FA (see FIG. 1) at the film surface are pressed and are pushed to the image reading reference plane S, by the pair of masks 24A, 24B which are moved in the direction of approaching the base plate 18.

Further, after this pressing by the masks 24A, 24B, as the mask holding members 26A, 26B are lowered, the belts 50 of the pair of tight-pressing units 40A, 40B, which are moved in the direction of approaching the base plate 18, tightly press the transverse direction both edge portions FB at the film surface. As shown in FIG. 4B, the photographic film F is set at the image reading section 14 with the both edge portions FB nipped between the belts 50 and the convex portions 22A, 22B of the base plate 18.

In this state, light (the arrow LT in FIG. 5B), which exits from the light source portion of the scanner device 80, passes through the base plate 18 and is illuminated onto the image frame P recorded on the photographic film F. The light transmitted through the image frame P (transmitted light) is imaged onto the light-receiving surface of the image pickup element 74 by the lens unit 72 of the scanner device 80. In this way, the film transmitted light is converted into an electric image signal by the image pickup element 74, and is read as an image.

Here, the trough-shaped curl, which arises in the photographic film F and which has curvature in the film transverse direction, is greatly reduced due to the both edge portions FA in the film conveying direction being pressed by the masks 24A, 24B, before the both edge portions FB in the film transverse direction are nipped between the belts 50 of the tight-pressing units 40A, 40B and the convex portions 22A, 22B of the base plate 18. Accordingly, even if there is a great curl, it can be reliably suppressed, and the photographic film F can be made to have good planarity.

Further, in the state in which the masks 24A, 24B have moved apart from the base plate 18 and pressing of the photographic film F is released, due to the relative movement of the mask holding members 26A, 26B due to the driving of the mask moving motor 34, the masks 24A, 24B are moved so as to approach and move away from one another along the film conveying direction in accordance with the size of the image frame P, and are disposed at a predetermined mask position. Due to this displacement of the masks 24A, 24B, changes in the image frame size in the conveying direction can be addressed without damaging the photographic film F.

With regard to a photographic film F in which a large, trough-shaped curl has arisen, if the pair of masks 24A, 24B which press the both edge portions FA in the film conveying direction are, for example, merely moved to the reference position along the light illuminating direction (the image reading reference plane S), there are cases in which a curl which exceeds an allowable range remains in the central portion of the photographic film F. Moreover, when the film conveying direction both edge portions FA are, for example, tightly pressed at the base plate 18 due to the pressing by the pair of masks 24A, 24B, there are cases in which an air pocket forms between the photographic film F and the base plate 18 and it is difficult to collapse the curl.

In such cases, the concave portion 20 may be provided along the film conveying direction at a region of the base plate 18 corresponding to the image frame P, and as shown by the two-dot chain line in FIG. 5B, the masks 24A, 24B may be moved to as to enter into the concave portion 20 of the base plate 18 by the amount ΔZ, and the conveying direction both edge portions FA at the photographic film F may be pressed. In this way, the both edge portions FA are pushed-in further than the reference position along the light illuminating direction, and it is possible to keep the curl C, which remains at the central portion of the photographic film, within the allowable range. Further, by stopping the masks 24A, 24B, which enter into the concave portion 20, at positions at which they do not contact the concave portion 20, the conveying direction both edge portions FA at the photographic film F are tightly pressed by the base plate 18, no air pocket is formed between the photographic film F and the base plate 18, and the curl C can be prevented from becoming hard to collapse.

In the present embodiment, the photographic film F, which is conveyed at the image reading section 14 along the film conveying path R, is conveyed by the belts 50 which are provided at the tight-pressing units 40A, 40B so as to be able to rotate and move along the conveying direction. Therefore, even short photographic films, which have been cut to a single frame or plural frames, can be conveyed automatically.

The aforementioned image frame detecting processing, which is carried out at the controller 90 which is structured as described above, will be described next.

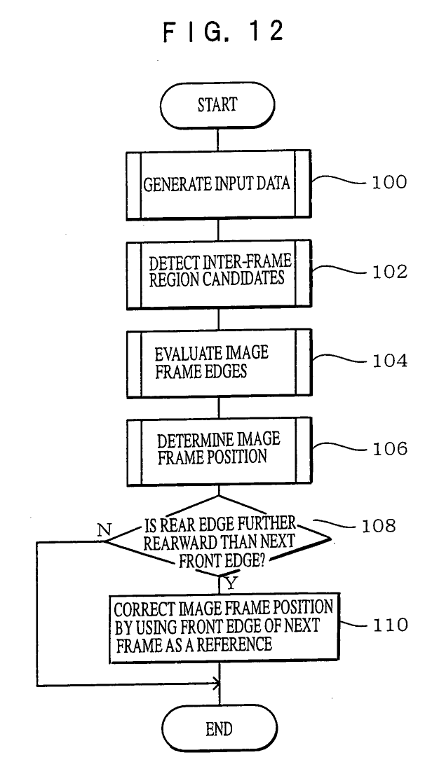

FIG. 12 is a flowchart showing the flow of the image frame detecting processing which is carried out at the controller 90 of the scanner device 80 relating to the embodiment of the present invention.

Due to the CPU 82A driving and controlling the respective motors of the film carrier 10 via the driver 88, the photographic film F is conveyed along the conveying path R. When the photographic film F passes over the image surface detecting sensors 98, the results of detecting the photographic film F by the image surface detecting sensors 98 are inputted to the controller 90.

At this time, if the image surface detecting sensors 98 are positioned between image frames at the time when the conveying of the photographic film F is stopped, a region between frames passes over the image surface detecting sensors 98 at times of acceleration and deceleration due to the conveying of the photographic film F. If a region between frames passes over the image surface detecting sensors 98 at times of acceleration and deceleration, the accuracy of detecting the image frame position deteriorates. Thus, in the present embodiment, by disposing the image surface detecting sensors 98 at a distance of 82 mm toward the photographic film F conveying direction upstream side from the reading center P of the image reading section 14 as described above, the image surface detecting sensors 98 are disposed at a position which is not between frames at the time when a given image frame is stopped at the reading central position of the image reading section 14, at brownie films of any image size. Therefore, detection by the image surface detecting sensors 98, which excludes the effects due to acceleration and deceleration of the conveying of the photographic film F, can be carried out.

When the image surface detection by the image surface detecting sensors 98 starts in this way, first, in step 100, the controller 90 generates input data. In the generation of input data, for example, the maximum value and the minimum value of each one pulse (e.g., a reference pulse controlling the respective motors of the film carrier 10) is generated from sampling data inputted from the image surface detecting sensors 98, or the average value of the output values from the six image surface detecting sensors 98 for each one pulse is generated from the sampling data, and the generated values are stored in a data buffer such as the RAM 82C or the like.

In step 102, by using the end of a clear leader or the front end of the film as a starting point of detection, the controller 90 carries out detection of inter-frame region candidates (edge candidates) within a detection range which is equal to a predetermined maximum frame width+a standard frame interval+a predetermined value (e.g., 5 mm), i.e., a range of detection of one frame, and the controller 90 detects edge candidates which are surmised to be between frames, from the film light amounts (the densities of the photographic film F) inputted from the image surface detecting sensors 98. In the detection of the inter-frame region candidates, for example, positions of maximum density (darkest portions) at a plurality (e.g., three) places among the data inputted from the six image surface detecting sensors within the detection range, are held, and the edges of the image frame from the respective maximum density positions toward the forward and rearward directions (the upstream and downstream directions in the conveying direction of the photographic film F) are detected. In a case in which the distance from the front edge of the frame, which is surmised to be the starting position of the image frame, is close to the set image size, it is between frames. Note that step 102 corresponds to the detecting section and the detecting of the present invention.

In step 104, the controller 90 evaluates the edges of the image frame. In this edge evaluation, the slopes of the edges, which are the density differences of respective edges, are computed as evaluation values for determining the edge to be used as a reference from among the inter-frame region candidates, and are compared. Namely, the density differences of the edges detected by the respective image surface detecting sensors 98 are compared. Note that step 104 corresponds to the comparing section and the comparing of the present invention.

Then, in step 106, the controller 90 extracts the edge whose density difference is largest, from among the results of edge evaluation of step 104, and determines the image frame position. For example, the density difference of the front edge of the image frame and the density difference of the rear edge are compared, and the edge whose density difference is largest is extracted. Then, by using the extracted edge as a reference, the image frame position is determined by taking into consideration the predetermined size of the image frame which is the object of reading.

At this time, the controller 90 can accurately determine the edge by further evaluating the rectilinearities of the front edge of the image frame (the edge of the image frame at the photographic film F conveying direction upstream side) and the rear edge (the edge of the image frame at the photographic film F conveying direction downstream side), by using the results of detection of the six image surface detecting sensors 98, and then using the edge which is more rectilinear as the reference. The controller 90 can thereby more accurately determine the image frame position.

In addition, widths of frames, slopes of edges, rectilinearities of edges, and the like may be evaluated, and edge determining positions corresponding to the results of evaluation may be prepared in advance as a table, and the image frame position may be determined by using the results of evaluation and the prepared table. Note that step 106 corresponds to the determining section and the determining of the present invention.

Next, in step 108, the controller 90 judges whether or not the rear edge will be further rearward than the front edge of the next image frame. If this judgment is affirmative, the routine moves on to step 110.

In step 110, the controller 90 surmises that the determined image frame position was not determined correctly, and in order to adjust the image frame position, corrects the image frame position by using the front edge of the next frame as a reference, and ends the image frame detecting processing. In the correction of the image frame position, the determined image frame position is corrected so that, for example, the rear edge of the determined image frame position is suited to the front edge of the next image frame.

If the judgment in step 108 is negative, image frame detection is completed.

In this way, in the present embodiment, due to the controller 90 carrying out image frame detection processing, an image frame position can be accurately determined from information of one frame of the photographic film F. At the time when the photographic film F is conveyed and stopped by the film carrier 10, the image frame can be accurately positioned at the reading central position of the image reading section 14 merely by the information of one frame. Accordingly, positioning of an image frame can be carried out with high accuracy, without making the film carrier 10 large.

The present invention has been described in detail by the above-described specific embodiment, but the present invention is not to be limited to this embodiment, and other, various forms can be embodied within the scope of the present invention.

Note that, if, while the above-described actual reading is being executed, the need arises to carry out the actual reading again due to the results of the inspection processing, the actual reading which is being executed may be discontinued, and the actual reading may be executed again.

In this way, the actual reading which was being carried out previously is discontinued in the midst thereof, and the image reading conditions are changed, and the actual reading is carried out again. Therefore, the scanning cycle can be prevented from becoming unnecessarily long.

In accordance with the present invention, after the inspection processing, fine scanning can be carried out again.

Plural types of recording media, whose image sizes in the direction orthogonal to the transverse direction which are recorded in a recording region of the same width are respectively different, can be used as the recording medium which is the object of reading. For example, a brownie film can be used as the recording medium. Namely, in brownie films, generally, plural types of image sizes of 6×4.5, 6×6, 6×7, 6×8, 6×9 can be recorded, and recording media of the respective image frame sizes can be used as objects of reading.

At the comparing section, the density differences of the plural edge candidates detected by the plural detecting sections are compared. At the determining section, on the basis of the results of comparison of the comparing section, the position of the image frame on the recording medium is determined by using, as a reference, the edge candidate whose difference value is large. For example, as in the invention of claim 2, the position of the image frame on the recording medium can be determined by using the preset image frame size, by using the edge candidate having the largest density difference as a reference. Accordingly, the image frame position can be accurately determined by using the information of one frame recorded on the recording medium. The image frame can thereby be accurately positioned at the reading position.

A plurality of the detecting sections are disposed along the transverse direction which is orthogonal to the conveying direction of the recording medium. Therefore, the determining section may determine the position of the image frame by detecting the edge which is to be used as a reference, by evaluating the rectilinearities of the edge candidates in the transverse direction, which is orthogonal to the conveying direction of the recording medium, on the basis of the comparison results of the comparing section. Namely, the image frame is determined by using a more rectilinear edge as a reference. Therefore, the edges can be detected accurately, and the position of the image frame can be determined more accurately.

Note that plural types of recording media, whose image sizes in the direction orthogonal to the transverse direction which are recorded in a recording region of the same width are respectively different, can be used as the recording medium which is the object of reading.

In the comparing, the density differences of the plural edge candidates which are detected, are compared. In the determining, the position of the image frame on the recording medium is determined by using the edge candidate having the largest density difference as a reference, on the basis of the comparison results of the comparing section. For example, the position of the image frame on the recording medium may be determined by using a preset image frame size, by using the edge candidate having the largest density difference as a reference. Accordingly, the image frame position can be accurately determined by using the information of one frame recorded on the recording medium. The image frame can thereby be accurately positioned at the reading position.

A plurality of the detecting sections are disposed along the transverse direction which is orthogonal to the conveying direction of the recording medium. Therefore, the determining may determine the position of the image frame by detecting the edge which is to be used as a reference, by evaluating the rectilinearities of the edge candidates in the transverse direction, which is orthogonal to the conveying direction of the recording medium, on the basis of the comparison results. Namely, the image frame is determined by using a more rectilinear edge as a reference. Therefore, the edges can be detected accurately, and the position of the image frame can be determined more accurately.

As described above, in accordance with the present invention, edges of a recording medium are detected by a plurality of detecting sections which are disposed along the transverse direction of recording medium. The densities of the edges detected by the detecting sections are compared, and the position of the image frame on the recording medium is determined by using the edge having the greatest density difference as a reference. The present invention therefore has the effect of being able to accurately determine an image frame position by using information of one frame recorded on a recording medium.

What is claimed is:

1. An image reading method comprising:
conveying a photographic film in a predetermined direction such that an image frame recorded on the photographic film is positioned at a predetermined reading position;
preliminarily reading an image by illuminating light onto the entire image frame;
actually reading the image frame at a higher resolution than during the preliminary reading;
displaying, on a display means, the image obtained by the preliminary reading;
executing the actual reading again in a case in which re-execution of the actual reading is instructed due to results of a predetermined inspection processing based on the image displayed on the display means; and
conveying the photographic film in the predetermined direction so that an image frame, which is a next object of reading, is positioned at the reading position.

2. The image reading method of claim 1, wherein, during execution of the actual reading, if a need arises to again execute the actual reading due to the results of the inspection processing, the actual reading which is being executed is discontinued, and actual reading is executed again.

3. The image reading method of claim 1, wherein the photographic film is a photographic film in which no perforations are formed.

4. An image reading device which conveys a recording medium on which image frames are recorded, and stops an image frame at a reading position, and reads an image, the image reading device comprising:
a plurality of detecting sections which are disposed along a transverse direction which is orthogonal to a conveying direction of the recording medium, and which, by detecting densities of the recording medium, detect a plurality of edge candidates of an image frame recorded on the recording medium;
a comparing section comparing density differences of the plurality of edge candidates detected by the plurality of detecting sections; and
a determining section which, on the basis of results of comparison of the comparing section, determines a position of an image frame on the recording medium by using an edge candidate having a large density difference as a reference.

5. The image reading device of claim 4, wherein the determining section determines the position of the image frame on the recording medium by using an image frame size which is set in advance.

6. The image reading device of claim 4, wherein the determining section determines the position of the image frame by detecting an edge which is to be used as a reference, by evaluating rectilinearities of the edge candidates in the transverse direction on the basis of the results of comparison of the comparing section.

7. The image reading device of claim 4, wherein the recording medium is a brownie film.

8. An image reading method of an image reading device which conveys a recording medium on which image frames are recorded, and stops an image frame at a reading position, and reads an image, the method comprising:
detecting a plurality of edge candidates of an image frame recorded on the recording medium, by detecting densities of the recording medium by a plurality of detecting sections which are disposed along a transverse direction which is orthogonal to a conveying direction of the recording medium;
comparing density differences of the plurality of edge candidates detected in the detecting; and
on the basis of results of comparison of the comparing, determining a position of an image frame on the recording medium by using an edge candidate having a large density difference as a reference.

9. The image reading method of claim 8, wherein the determining includes determining the position of the image frame on the recording medium by using an image frame size which is set in advance.

10. The image reading method of claim 8, wherein the determining includes determining the position of the image frame by detecting an edge which is to be used as a reference, by evaluating rectilinearities of the edge candidates in the transverse direction on the basis of the results of comparison of the comparing.

11. The image reading method of claim 8, wherein the recording medium is a brownie film.
